(19) United States
(12) Patent Application Publication
(10) Pub. No.: US 2026/0310166 A1
(43) Pub. Date: Oct. 8, 2026

(54) THREE-DIMENSIONAL CRAFT PRODUCT AND METHOD FOR FABRICATING THE SAME USING IMAGE-DERIVED MATERIAL REMOVAL

(71) Applicant: Michael Kalish, Los Angeles, CA (US)

(72) Inventor: Michael Kalish, Los Angeles, CA (US)

(21) Appl. No.: 19/460,265

(22) Filed: Jan. 26, 2026

Related U.S. Application Data
(60) Provisional application No. 63/725,794, filed on Nov. 27, 2024.

(51) Int. Cl. G05B 19/4099; G06T 7/11; G06T 19/20

(52) U.S. Cl. CPC G05B 19/4099; G06T 7/11; G06T 19/20; G05B 2219/49246; G06T 2207/10024; G06T 2219/2012; G06T 2219/2016

(57) ABSTRACT

Computer-controlled fabrication of three-dimensional transparent sculptures incorporating physical source media to form a craft product is disclosed. A source image is processed by a computing system to generate vector geometry defining material-retention regions and material-removal regions based on image segmentation. Computer-controlled fabrication equipment removes material from a transparent or translucent substrate to form negative spaces and retained structural members arranged to correspond to the source image. Physical source media is aligned with and secured to the retained structural members such that portions of the source media are exposed through the negative spaces. The retained structural members, negative spaces, and ambient light cooperate to optically reconstruct a composite visual image when viewed from a distance. In certain embodiments, the structure is supported in a spaced relationship relative to a background surface to enhance visual depth and contrast.

### CROSS-REFERENCE TO RELATED APPLICATION

This application claims the benefit of U.S. Provisional Serial No. 63/725794 entitled Craft Product and Method of Making the Same filed Nov. 27, 2024, entire contents of each which are incorporated by reference herein for all purposes.

### TECHNICAL FIELD

The present disclosure relates to fabricated articles of manufacture and methods for producing the same. More particularly, the disclosure relates to computer-controlled fabrication of three-dimensional transparent sculptures incorporating physical source media, including but not limited to film and image strips through material-removal processes that generate optically functional negative spaces.

### BACKGROUND

Efforts to incorporate visual information into transparent or translucent structures have taken many forms across artistic, decorative, and display-related fields. Certain approaches rely on placing images behind transparent panels, affixing images to a surface, or arranging visual elements in proximity to a clear substrate. While such approaches may allow an observer to view an image through a transparent material, they do not address the technical challenges associated with forming a three-dimensional article in which the structure of the transparent material itself contributes to image formation through controlled interaction with light and depth.

In some contexts, image composition techniques have been applied in which multiple smaller image elements are arranged to approximate a larger image. Such techniques are typically applied in digital environments or planar printed media and are primarily concerned with color or tonal matching rather than with physical material transformation. These approaches do not contemplate the translation of image data into manufacturing instructions that permanently alter transparent thermoplastic materials to form apertures, slats, or negative spaces that participate in optical image formation when combined with physical source media and ambient light.

Other approaches involve cutting or shaping transparent materials for decorative or informational purposes, such as forming patterns, silhouettes, or ornamental cutouts. These approaches generally treat material removal as an end in itself or as a purely decorative feature, without coordinating the removed regions with physical source media to generate a composite image that varies in appearance based on viewing distance or lighting conditions. Such techniques do not address the problem of maintaining structural integrity while producing optically functional negative spaces that contribute meaningfully to image recognition.

In addition, certain fabrication techniques rely on lamination or full encapsulation of image-bearing materials within transparent substrates. While such arrangements may physically secure an image, they tend to isolate the image from environmental light interaction and do not enable the transparent structure to modulate light in a controlled manner. Moreover, fully encapsulated configurations can complicate repair, replacement, or selective modification of source media, and do not contemplate maintaining source media in a non-encapsulated or partially exposed state while still providing structural support.

Computer-based image editing and vectorization tools are capable of manipulating digital representations of images for display or printing. However, such tools are not directed to generating manufacturing control data that defines how material is to be physically removed from transparent thermoplastic substrates in a manner that produces optically functional structures. The use of digital image tools in isolation does not provide a solution for coordinating image-derived geometry with material-removal processes to fabricate a three-dimensional article whose visual output is dependent on physical depth, spacing, and light transmission.

Similarly, computer numerical control machining systems are capable of removing material from plastic substrates according to predefined toolpaths. In known applications, such systems are employed to form panels, signs, or decorative elements. These uses do not address the technical problem of translating image information into routed geometries that cooperate with physical source media and ambient light to form a composite visual image, nor do they address fabrication techniques that preserve the longevity of fragile source materials while enabling optical depth and contrast effects.

Accordingly, there exists a need for fabrication methods and articles that integrate digital image processing with computer-controlled material removal in a manner that produces a three-dimensional transparent structure incorporating physical source media and having optically functional negative spaces.

### SUMMARY

The present disclosure provides systems, methods, and articles of manufacture for producing three-dimensional sculptural structures formed from materials (in some cases that are transparent) and physical source media or substrate. The disclosed techniques integrate digital image processing with computer-controlled material-removal operations to fabricate transparent structures having optically functional negative spaces that cooperate with embedded source media and ambient light to generate a composite visual image or sculpture.

In accordance with one aspect of the disclosure, a method is provided in which a source image is processed by a computing system to generate a vectorized fabrication model. The fabrication model defines regions of material retention and material removal corresponding to image-derived geometry. The vectorized model is converted into machine-readable toolpaths that control a computer numerical control routing system. The routing system physically removes material from one or more substrates, in an embodiment, transparent thermoplastic sheets, forming apertures, slats, and structural members having predetermined dimensions and spatial relationships.

The material-removal process permanently transforms the thermoplastic substrate, resulting in a three-dimensional physical structure whose geometry directly influences light transmission, contrast, and image recognition. Physical source media, including film strips or image-bearing segments, are aligned with and affixed to the routed thermoplastic structure such that portions of the source media are exposed through the routed apertures. In this configuration, the transparent structure, the source media, and the surrounding environment cooperate to produce a composite image that varies in appearance based on viewing distance and ambient lighting conditions.

In certain embodiments, the routed substrate (e.g., thermoplastic structure) comprises multiple aligned layers that sandwich the source media while maintaining airflow and avoiding full encapsulation. This layered configuration improves the durability and longevity of the source media, facilitates selective repair or replacement, and preserves optical performance over time. The structure may be secured within a rigid frame that maintains a spaced relationship between the structure and a background surface, enabling ambient light to pass through the apertures and interact with the source media to enhance depth perception and contrast.

In another embodiment, the disclosure provides a three-dimensional craft product such as a sculptural article comprising at least one transparent thermoplastic sheet having a plurality of routed apertures extending therethrough, physical source media affixed to the thermoplastic sheet and aligned with the apertures, and a frame configured to support the thermoplastic sheet in a manner that permits controlled light transmission. The article constitutes a tangible article of manufacture having structural, optical, and durability characteristics resulting from irreversible material-removal processes.

The disclosure defines digital image processing operations that function as control inputs for computer-controlled fabrication equipment that physically alters substrates such as thermoplastic materials to produce an article, such as a sculpture. The resulting articles exhibit technical effects, including but not limited to controlled modulation of light, repeatable image formation through structural geometry, and improved preservation of physical source media, which are not achievable through manual fabrication or mental visualization alone.

In one aspect, a method is disclosed in which a source image is processed by a computing system to generate a manufacturing-ready digital representation. The processed image is used to generate vector geometry defining material-retention regions and material-removal regions based on image-derived segmentation. The vector geometry is converted into machine-readable fabrication data that controls automated material-removal equipment, such as a computer numerical control routing system, to form negative spaces extending through at least one transparent or translucent substrate while retaining structural members arranged in a predetermined spatial relationship. Physical source media is aligned with and secured to the retained structural members such that portions of the source media are exposed through the negative spaces. The resulting composite structure cooperates with ambient light and a background surface to produce a depth-dependent visual image. The composite structure may be assembled into a framed article configured to maintain a spaced relationship relative to the background surface to enhance optical contrast and depth perception.

In another aspect, the disclosure provides a three-dimensional craft product comprising at least one transparent or translucent substrate having a plurality of negative spaces extending through a thickness of the substrate, the negative spaces being formed by computer-controlled material removal based on image-derived segmentation geometry. A plurality of retained structural members is defined between the negative spaces and arranged in a predetermined spatial relationship corresponding to a processed source image. Physical source media is secured to the substrate and aligned with the retained structural members such that portions of the source media are exposed through the negative spaces. The retained structural members and the negative spaces cooperatively interact with ambient light and a background surface to optically reconstruct a composite visual image when viewed from a macroscopic viewing distance. In certain embodiments, a frame supports the substrate in a spaced relationship relative to the background surface to permit light transmission through the negative spaces and enhance visual depth and contrast.

The disclosed systems, methods, and articles provide several technical advantages over prior fabrication approaches. The integration of digital image processing with computer-controlled material removal enables precise, repeatable formation of optically functional negative spaces within transparent thermoplastic materials, resulting in predictable light transmission and image recognition characteristics across multiple fabricated instances to create a craft product or sculpture in certain instances. The use of routed apertures and structural slats allows the transparent material itself to participate in image formation, rather than merely serving as a passive protective layer. The layered assembly configuration preserves physical source media without full encapsulation, improving longevity while permitting selective repair or replacement. Additionally, the framed mounting arrangement enhances optical depth and contrast using ambient light without requiring powered illumination. Collectively, these features enable scalable manufacturing of three-dimensional transparent structures exhibiting controlled optical performance, structural integrity, and serviceability that are not achievable through manual fabrication, planar image arrangements, or decorative cutout techniques.

### BRIEF DESCRIPTION OF FIGURES

The accompanying drawings, which are incorporated herein and form part of the specification, illustrate exemplary embodiments of the disclosed subject matter and, together with the description, serve to explain the principles of the disclosure. The drawings are not necessarily to scale, and emphasis is placed on illustrating structural and functional relationships

FIG. 1 is a schematic flow diagram illustrating an exemplary method for manufacturing a three-dimensional transparent sculptural article using digital image processing and computer-controlled material removal, in accordance with embodiments of the present disclosure.

FIG. 2 is a partial perspective view illustrating components of a transparent thermoplastic structure formed from routed material and physical source media, showing negative spaces and retained structural regions.

FIG. 3 is a perspective view illustrating an assembled portion of the sculptural structure, including routed slats, negative spaces, and interaction with a background surface to produce optical contrast.

FIG. 4 is an enlarged detail view of a portion of the sculptural structure, illustrating alignment of physical source media with routed apertures formed in a transparent thermoplastic substrate.

FIG. 5 is a front perspective view illustrating exemplary completed three-dimensional sculptural articles formed in accordance with the disclosed methods.

FIG. 6 is a detailed view of an exemplary sculptural article showing how multiple source media elements cooperate with routed transparent structures to form a composite visual image.

FIG. 7 is an exploded and assembled view illustrating an exemplary framing and mounting configuration for supporting the transparent sculptural structure in a spaced relationship relative to a background surface.

FIG. 8 is an exemplary system architecture for a manufacturing a three-dimensional transparent sculptural article using digital image processing and computer-controlled material removal, in accordance with embodiments of the present disclosure.

### DETAILED DESCRIPTION

Exemplary embodiments are discussed below with reference to the Figures.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

Those skilled in the art will recognize that this example is illustrative and not limiting and is provided purely for explanatory purposes. An example of a computing system environment is disclosed. The computing system environment is not intended to suggest any limitation as to the scope of use or functionality of the system and method described herein. Neither should the computing environment be interpreted as having any dependency or requirement relating to any one or combination of components illustrated in the exemplary operating environment.

Embodiments of the disclosure are operational with numerous other general purposes or special purpose computing system environments or configurations. The embodiments of the disclosure may be described in the general context of computer-executable instructions, such as program modules, being executed by a computer or smart device. Generally, program modules include routines, programs, objects, components, data structures, etc. that perform particular tasks or implement particular data types. The systems and methods described herein may also be practiced in distributed computing environments where tasks are performed by remote processing devices that are linked through or overlayed by a communications network. In a distributed computing environment, program modules may be located in both local and remote computer storage media including memory unit(s) or storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

Computers and smart devices may comprise a variety of computer readable media. Computer readable media can be any available media that can be accessed by computer and comprises both volatile and non-volatile media, removable and non-removable media. By way of example, and not limitation, computer readable media may include computer storage media and communication media. Computer storage media comprises both volatile and non-volatile, removable and non-removable media implemented in any method or technology for storage of information such as computer readable instructions, data structures, program modules or other data.

The non-transitory computer-readable media includes all types of computer-readable media or mediums, including magnetic storage media, optical storage media, and solid-state storage media and specifically excludes signals. It should be understood that the software can be installed in and sold with the device. Alternatively, the software can be obtained and loaded into the device, including obtaining the software via a disc medium or from any manner of network or distribution system, including, for example, from a server owned by the software creator or from a server not owned but used by the software creator. The software can be stored on a server for distribution over the Internet.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The described embodiments are to be considered in all respects only as illustrative and not restrictive. The scope is, therefore, indicated by the appended claims rather than by the foregoing description. All changes that come within the meaning and range of equivalency of the claims are to be embraced within their scope.

As used herein, the term “craft product” refers to a physically manufactured article produced through a combination of digital processing and material fabrication operations, wherein digitally derived geometry is executed by automated or semi-automated fabrication equipment to form a tangible object having functional structural features. Accordingly, a craft product as disclosed herein is distinguished from purely artistic concepts or abstract designs and instead constitutes an article of manufacture resulting from a technically defined image-to-fabrication process, wherein digital image data, vector geometry, and fabrication parameters cooperatively determine the physical structure and optical characteristics of the finished product.

As used herein, the term “source material” means any image, design, pattern motif and the like, made by the artist or another party including but not limited to computer generated materials.

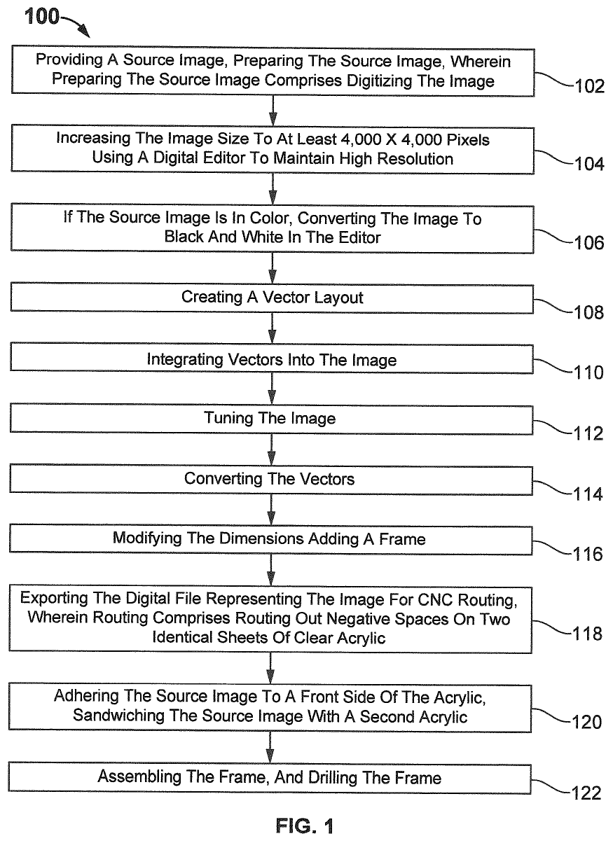

Referring now to FIG. 1, a stepwise diagram illustrating a method (100) for producing a craft product, such as a three-dimensional acrylic sculpture, utilizing source media in the form of film-based portrait imagery is shown. The method (100) combines digital image processing performed by a computing system with physical fabrication techniques using transparent or translucent substrates. Although a film portrait is illustrated as an exemplary source material, the method is not so limited and may be applied to photographs, digital images, illustrations, video stills, graphic artwork, or other visual source media.

At step (102), a source material is selected and prepared by a user, artist, curator, automated selection process, or a combination thereof. The source material may originate from analog media, including photographic film strips, negatives, transparencies, slides, or printed photographs, or from digital media, including image files captured by digital cameras, scanners, mobile devices, or obtained from remote databases or networked storage systems. In some embodiments, multiple source materials may be selected and aggregated to form a composite source image.

Preparation of the source material, shown at step (104), comprises digitizing, normalizing, and scaling the source material to a resolution suitable for computational image processing and subsequent physical fabrication. Where the source material originates from analog media, the preparation step may include scanning the analog media using a high-resolution scanner to produce a digital raster image. The digitized source material may then be normalized for orientation, aspect ratio, and alignment to ensure compatibility with downstream processing steps.

In one embodiment, based on the intended physical dimensions of the final sculpture or craft product, the thickness of the fabrication substrate, and the minimum feature size achievable by the fabrication equipment, the source material is scaled to a resolution of at least approximately 3,000×3,000 pixels. In more specific embodiments, the source material is scaled to a resolution in the range of approximately 3,500×3,500 pixels to 8,000×8,000 pixels. In still more specific embodiments, the source material is scaled to a resolution of approximately 4,000×4,000 pixels to 6,000×6,000 pixels. In yet further embodiments, the source material is scaled to a resolution of approximately 4,000×4,000 pixels, 5,000×5,000 pixels, or 6,000×6,000 pixels.

Scaling may be performed using interpolation techniques designed to preserve edge sharpness, tonal gradients, and fine image detail, thereby reducing aliasing artifacts and distortion during subsequent vectorization and cutting operations. The scaling operation is performed by executing image-processing instructions on the computing system, for example, using a photo editing application capable of non-destructive scaling and resolution enhancement.

In other embodiments, higher resolutions, such as greater than 6,000×6,000 pixels, including resolutions in the range of approximately 6,500×6,500 pixels to 12,000×12,000 pixels, may be used for larger crat products or sculptures, sculptures intended to be viewed at closer distances, or sculptures requiring increased perceptual detail. The selected resolution may be automatically determined by the computing system based on one or more parameters, including desired output size, fabrication tolerances of the CNC routing system, and characteristics of the source material itself.

During preparation, the source material may further undergo pre-processing operations, including noise reduction, contrast normalization, tonal balancing, and/or sharpening, to improve the stability and accuracy of later segmentation and vector-generation steps. These preparation operations ensure that the source material is converted into a manufacturing-ready digital representation that can be reliably transformed into vector geometry and physical cut paths without loss of critical visual information.

The pixel-resolution ranges described above are not arbitrary selections or matters of aesthetic preference but instead are technically significant parameters that directly affect manufacturability, structural accuracy, and perceptual image reconstruction in the fabricated acrylic sculpture. Selection of a resolution below the disclosed ranges results in insufficient spatial data density, which degrades edge definition, causes loss of tonal separation during thresholding and vectorization, and produces imprecise or unstable cut paths when executed by computer-controlled fabrication equipment. Such degradation materially impairs the ability to reliably translate the source material into physically segmented components that reconstruct the intended image.

Conversely, selection of a resolution within the disclosed ranges provides a functional advantage by maintaining a minimum pixel-to-toolpath ratio that enables accurate raster-to-vector conversion, predictable CNC routing behavior, and consistent formation of negative spaces having geometries that cooperate with the source material to form a perceptually coherent three-dimensional image. The disclosed ranges further balance computational efficiency with fabrication precision, reducing excessive processing overhead while preserving sufficient detail to accommodate minimum feature sizes achievable by the cutting tools.

Accordingly, the disclosed resolution ranges are technically constrained by the interaction between digital image processing, vector generation, and physical material-removal operations, and provide an improvement to image-based fabrication workflows. These ranges enable reliable, repeatable production of the disclosed acrylic sculptures and therefore represent functional limitations tied to the operation of the computing system and fabrication equipment, rather than mere design choices.

Additionally, if the source material is in color, the source material may optionally be converted to grayscale or black-and-white at step (106). The conversion is performed as a computational image-processing operation executed by the computing system and is configured to enhance contrast, tonal separation, and feature detectability for downstream segmentation, vectorization, and fabrication steps. In one embodiment, grayscale conversion is performed using channel mixing, wherein weighted contributions of red, green, and blue color channels are combined according to predefined or adjustable coefficients. In other embodiments, luminance mapping is employed, wherein perceived brightness values are calculated based on human visual sensitivity to different wavelengths, thereby preserving perceptually significant features such as facial contours, edges, and shadow gradients.

In further embodiments, adaptive grayscale conversion techniques may be used, including local contrast enhancement, histogram equalization, or region-based luminance normalization, to improve separation between adjacent image regions that will ultimately correspond to segmented bars and negative spaces. These techniques reduce loss of detail during subsequent thresholding and vector tracing operations and improve the stability of generated cut paths.

In some embodiments, rather than full grayscale conversion, selective color retention or partial desaturation may be applied. For example, one or more color channels or hue ranges may be preserved while remaining portions of the image are desaturated. This selective processing enables certain visual elements of the source material to remain distinguishable after physical fabrication, while still maintaining sufficient contrast for accurate segmentation and CNC routing. Partial desaturation may also be applied in a spatially varying manner, such that regions corresponding to critical structural features are converted to grayscale while non-critical regions retain color information.

The choice of grayscale conversion, selective color retention, or partial desaturation directly affects the thresholding behavior, vector boundary formation, and resulting geometry of negative spaces produced during fabrication. Improper conversion may result in loss of edge definition or merging of adjacent features, whereas conversion performed in accordance with the disclosed techniques improves manufacturability and perceptual reconstruction of the final three-dimensional acrylic sculpture. Accordingly, the color-to-grayscale processing step constitutes a technical operation integrated into the image-to-fabrication pipeline, rather than a purely aesthetic modification.

At step (108), a vector layout is created. This step comprises generating a machine-interpretable vector-based defining a plurality of elongated bars, slats, or columns having predetermined widths, spacing, lengths, and orientations. The vector layout functions as a segmentation mask that governs how the source material will be physically divided during fabrication. The number of bars and their respective dimensions are selected based on one or more parameters including the intended physical dimensions of the sculpture, the resolution of the source material, the minimum feature size achievable by the fabrication equipment, and the desired perceptual fidelity of the reconstructed image.

In exemplary embodiments, each bar has a width in the range of approximately 0.5 mm to 25 mm. In more specific embodiments, the bar width is in the range of approximately 1 mm to 15 mm. In still more specific embodiments, the bar width is in the range of approximately 2 mm to 8 mm, and in certain preferred embodiments is approximately 3 mm, 4 mm, 5 mm, or 6 mm. These ranges allow the bar geometry to be scaled to accommodate different sculpture sizes, viewing distances, and fabrication tolerances.

The spacing between adjacent bars, corresponding to the negative spaces formed during CNC routing, may likewise be selected within a functional range. In one embodiment, the spacing between bars is in the range of approximately 0.5 mm to 20 mm. In more specific embodiments, the spacing is in the range of approximately 1 mm to 10 mm, and in still more specific embodiments in the range of approximately 2 mm to 6 mm. The spacing may be uniform across the layout or may vary spatially based on image characteristics.

The bars are configured to segment the source material into discrete portions such that, when negative spaces are physically formed between adjacent bars during CNC routing, the remaining material cooperates with the background and lighting conditions to optically reconstruct the source image at a macroscopic viewing distance. The vector layout therefore defines both material-retention regions and material-removal regions, directly controlling the geometry of the negative spaces that contribute to contrast enhancement, depth perception, and three-dimensional visual effect.

In one embodiment, the vector layout is created using a vector-editing application and subsequently imported into the image-processing environment as a smart object to enable non-destructive alignment and adjustment relative to the source material. The bars may be arranged in vertical, horizontal, diagonal, curved, radial, or non-uniform orientations. In some embodiments, bar orientation is selected to align with dominant directional features of the source image, such as facial contours, edges, or luminance gradients, thereby improving perceptual reconstruction after physical segmentation.

In certain embodiments, the spacing and width of the bars are mathematically constrained by both the pixel density of the source material and the minimum cutting diameter of the CNC routing tool, such that each bar and each negative space is representable by a sufficient number of pixels prior to vectorization and is physically producible by the machine tool without distortion.

In one exemplary embodiment, the source material is processed so that each bar width and each negative-space width corresponds to at least approximately 3 to 10 pixels, and more preferably 5 to 8 pixels, in the raster image prior to vector conversion. This relationship ensures that thresholding and vector tracing operations produce stable, continuous vector boundaries that align with physical cutting paths.

By way of example, where a CNC routing system utilizes a ⅛-inch (3.175 mm) cutting bit, the negative-space width is selected to be at least approximately 3.5 mm to 5.0 mm, corresponding to pixel-domain representations within the disclosed resolution ranges (e.g., 4,000×4,000 pixels to 6,000×6,000 pixels for typical artwork dimensions). Selecting bar spacing below this range results in under-resolved features that cannot be reliably cut, whereas selecting spacing within the disclosed ranges yields predictable CNC toolpaths and dimensionally accurate negative spaces.

Accordingly, the bar width and spacing ranges are functionally derived from and constrained by the interaction between digital pixel resolution and physical cutting tool geometry, enabling reliable raster-to-vector translation and automated material removal. These parameters therefore provide a technical improvement in image-based fabrication workflows and do not represent arbitrary or aesthetic design choices.

At step (110), the source material and the vector layout are integrated through a computational image-processing pipeline executed by the computing system. This integration step aligns the raster source material with the vector-defined segmentation geometry to produce a manufacturing-ready composite representation that directly governs subsequent vector tracing and CNC routing operations. In one embodiment, the source material is converted into a smart object within the image-processing environment, enabling non-destructive editing and preservation of original image data while successive filters and adjustments are applied.

A Gaussian Blur filter is applied to the source material as a smart filter to selectively attenuate high-frequency spatial components of the image. In exemplary embodiments, the Gaussian Blur filter is applied with a blur radius in the range of approximately 0.5 pixels to 20 pixels. In more specific embodiments, the blur radius is in the range of approximately 1 pixel to 12 pixels. In still more specific embodiments, the blur radius is in the range of approximately 2 pixels to 8 pixels, and in certain preferred embodiments is approximately 3 pixels, 4 pixels, 5 pixels, or 6 pixels. These nested ranges provide sufficient smoothing to reduce pixel-level noise and aliasing artifacts while preserving edge transitions corresponding to dominant image features.

Selection of a blur radius above the disclosed ranges may excessively smooth image features, causing loss of structural detail and degradation of perceptual reconstruction in the fabricated sculpture. Accordingly, blur radii within the disclosed ranges provide a functional advantage by stabilizing tonal gradients across adjacent bars and negative spaces, improving continuity of vector outlines and predictability of CNC toolpaths.

One or more adjustment layers, including curves and levels, are applied to the blurred source material to computationally reshape the tonal distribution of the image. These adjustment layers enable controlled expansion or compression of dynamic range, enhancement of mid-tone contrast, and normalization of shadow and highlight regions. Adjustment parameters may be selected manually or automatically based on histogram analysis, contrast metrics, or detected feature density. The resulting tonal conditioning ensures that the composite image produces stable, continuous threshold boundaries during subsequent binarization and vector conversion.

In some embodiments, the vector layout itself may also be subjected to controlled filtering prior to merging with the source material. For example, a Gaussian Blur having a blur radius in the range of approximately 0.25 pixels to 5 pixels, more preferably 0.5 pixels to 3 pixels, may be applied to soften vector-raster boundary transitions and reduce discontinuities at bar edges. The blurred vector layout and conditioned source material are then processed together as a unified composite structure for thresholding.

In some embodiments, a Gaussian Blur filter may also be applied to the vector bars themselves to slightly soften their edges prior to merging with the source material. A Threshold filter may then be applied to both the source material and the vector bars to convert the composite image into a high-contrast representation, effectively blending the image content with the bar structure. This thresholding step assists in defining cut paths and negative spaces that translate effectively into physical material removal during fabrication.

At step (112), the composite image is tuned within the image-processing environment through a controlled, iterative conditioning process executed by the computing system. This tuning step operates on the composite representation produced at step (110) and is configured to optimize the interaction between raster image features and the vector-defined segmentation geometry prior to raster-to-vector conversion and physical fabrication. The tuning process directly affects threshold stability, vector boundary continuity, and dimensional accuracy of negative spaces produced during CNC routing.

The tuning process may include iterative computational adjustments to one or more parameters, including threshold values, curve profiles, level endpoints, blur radius, or combinations thereof. In exemplary embodiments, the threshold value used to binarize the composite image is selected within a range of approximately 1 to 254 on an 8-bit grayscale scale. In more specific embodiments, the threshold value is selected within a range of approximately 50 to 200. In still more specific embodiments, the threshold value is selected within a range of approximately 90 to 150, and in certain preferred embodiments is approximately 110, 120, 128, 135, or 145. These ranges allow controlled classification of material-retention regions and material-removal regions while maintaining continuity of vector outlines.

Curve and level adjustments are applied to reshape the tonal distribution of the composite image prior to thresholding. In exemplary embodiments, level endpoint adjustments include setting a black point in the range of approximately 0 to 50 and a white point in the range of approximately 205 to 255. In more specific embodiments, the black point is set in the range of approximately 5 to 30 and the white point in the range of approximately 220 to 250. In still more specific embodiments, the black point is set in the range of approximately 10 to 20 and the white point in the range of approximately 230 to 245. These ranges compress or expand dynamic range to prevent shadow collapse or highlight saturation during thresholding.

In embodiments employing curve adjustments, one or more control points may be applied to adjust mid-tone contrast. In exemplary embodiments, mid-tone curve adjustments apply a gain factor in the range of approximately 0.8 to 1.4. In more specific embodiments, the gain factor is in the range of approximately 0.95 to 1.25, and in still more specific embodiments in the range of approximately 1.05 to 1.15. Such curve adjustments selectively enhance facial contours, edges, and luminance gradients that contribute to stable segmentation without introducing noise artifacts.

The tuning process may be performed iteratively, wherein threshold values, curve profiles, level endpoints, and blur radius are adjusted in successive passes until the composite image yields stable, continuous threshold boundaries and manufacturable vector geometry. The tuning may be guided visually by a user or artist through real-time previews, or may be partially or fully automated using preset profiles or optimization algorithms. In automated embodiments, the computing system evaluates histogram distributions, edge-density metrics, or vector preview stability metrics and converges on parameter values that satisfy predefined manufacturability criteria, such as minimum feature size, CNC bit diameter, and allowable kerf variation.

Once the desired balance between image detail and bar segmentation is achieved such that the composite image produces dimensionally stable, machine-executable vector paths, the tuned file is saved in a manufacturing-ready digital format suitable for subsequent vector conversion and CNC execution. The saved file preserves the tuned parameter values to ensure repeatability and consistency during downstream fabrication steps.

At step (114), vector conversion occurs. This step comprises transforming the tuned composite image from a raster-based representation into machine-interpretable vector geometry suitable for automated fabrication. In one embodiment, the tuned file is imported into a vector-editing environment, such as Adobe® Illustrator; however, other vectorization environments capable of raster-to-vector conversion may be used. The vector conversion step operates on the tuned raster image produced at step (112) and is configured to generate continuous, closed vector paths corresponding to material-retention regions and material-removal regions defined by the composite image.

The raster image may be converted to vector outlines using a tracing function, such as “Image Trace,” “Material Trace,” or an equivalent vectorization algorithm. The tracing function analyzes pixel-level transitions in the tuned image and generates vector paths that approximate detected boundaries. In exemplary embodiments, the tracing operation is performed in black-and-white mode, such that pixel values are classified into binary regions corresponding to retained material and removed material. This binary classification ensures deterministic vector boundaries and reduces ambiguity during subsequent CNC routing.

In exemplary embodiments, a threshold parameter used during tracing is nominally set at approximately 128 on an 8-bit grayscale scale, but is adjustable within a range of approximately 1 to 154. In more specific embodiments, the threshold parameter is selected within a range of approximately 90 to 150, and in certain preferred embodiments within a range of approximately 110 to 135, consistent with the tuning performed at step (112). Selection of the threshold parameter within these ranges ensures alignment between the tuned raster image and the resulting vector geometry.

The tracing operation further includes adjustment of a path fidelity parameter, which controls the degree to which the generated vector paths conform to underlying raster boundaries. In exemplary embodiments, the path fidelity is set at approximately 50%, but may be adjusted within a range of approximately 30% to 100%. Lower values simplify vector geometry by smoothing minor variations, while higher values preserve fine detail at the expense of increased vector complexity. Selection within the disclosed ranges balances geometric accuracy with manufacturability and CNC execution efficiency.

A corner detection parameter may also be applied to control preservation of angular features during tracing. In exemplary embodiments, corner detection is set at approximately 42%, but may be adjusted within a range of approximately 20% to 100%. This parameter affects how sharply corners and directional changes are represented in the resulting vector paths and may be selected based on desired bar geometry and minimum feature size constraints.

A noise reduction parameter may further be applied to suppress small, isolated artifacts in the raster image that would otherwise generate undesirable micro-features in the vector geometry. In exemplary embodiments, noise reduction is nominally set at approximately 1 pixel, but may be adjusted within a range of approximately 1 to 30 pixels, depending on source-material quality and resolution. Noise reduction within the disclosed ranges reduces formation of non-manufacturable features that fall below CNC tool diameter or kerf tolerances.

During tracing, one or more tracing options may be enabled to improve manufacturability and vector integrity. For example, selecting “Fills” causes the tracing operation to generate closed vector regions suitable for material retention; selecting “Snap Curves to Lines” reduces excessive Bézier complexity and aligns vector segments with linear cutting paths; and selecting “Ignore White” suppresses vector generation in background regions designated for material removal. These options collectively ensure that the resulting vector geometry is compatible with automated routing operations.

After tracing, the traced image is expanded to convert the generated paths into fully editable vector geometry. Expansion produces discrete vector objects representing bars, slats, negative spaces, and frame boundaries. The expanded vector geometry may be further inspected, merged, simplified, or validated to ensure continuity, closure, and compliance with fabrication constraints. The resulting vector file constitutes a fabrication-ready data structure that directly defines CNC toolpaths and governs physical material removal in subsequent steps.

At step (116), dimensional modification and frame integration occur. This step comprises modifying the vectorized image geometry to incorporate structural margin regions and frame-engagement features that enable reliable fabrication, assembly, and display of the acrylic sculpture. The dimensional modification is performed as a function of fabrication tolerances, material thickness, and frame-mounting requirements, rather than as a purely aesthetic resizing operation.

In exemplary embodiments, the top and bottom edges of the vectorized image are extended to form margin regions that accommodate clamping, fastening, concealment by a frame, and post-processing operations such as sanding or polishing. In broad embodiments, each edge extension is selected in the range of approximately 0.03125 inches to 0.75 inches. In more specific embodiments, the extension is selected in the range of approximately 0.0625 inches to 0.5 inches. In still more specific embodiments, the extension is selected in the range of approximately 0.09375 inches to 0.25 inches, and in certain preferred embodiments is approximately 0.125 inches, 0.15625 inches, or 0.1875 inches. These nested ranges provide sufficient structural tolerance to account for CNC kerf width, acrylic thickness variation, and dimensional drift during routing and finishing, while minimizing intrusion into the visually segmented image region.

Following edge extension, a surrounding frame geometry is added to the vectorized image. The frame geometry defines an outer perimeter corresponding to the external frame dimensions and an inner perimeter corresponding to the visible image opening. In one exemplary embodiment, the outer dimensions are approximately 42 inches by 32 inches, and the inner dimensions are approximately 38.8125 inches by 30 inches. In other embodiments, the outer dimensions may be selected within a range of approximately 18 inches by 12 inches to 72 inches by 60 inches, with corresponding inner dimensions scaled proportionally based on frame thickness, acrylic thickness, and desired reveal width.

The frame geometry serves multiple functional purposes. First, it provides a structural interface for mechanically retaining the acrylic components within an external frame, including accommodating fasteners, clamps, or interframe elements. Second, it provides a concealment margin that hides the routed top and bottom edges of the acrylic, masking minor fabrication imperfections and ensuring a uniform visual boundary. Third, the frame geometry establishes a dimensional buffer that allows post-fabrication finishing operations, such as edge sanding or polishing, without encroaching upon the segmented image area.

In some embodiments, the frame geometry further incorporates alignment and registration features, such as straight reference edges, relief cutouts, or datum surfaces, that ensure consistent positioning of the acrylic components during assembly. The geometry may also be configured to distribute mechanical loads evenly across the acrylic, reducing stress concentrations and improving long-term structural stability.

The image vectors defining the segmented bars and negative spaces and the frame vectors defining the border geometry are then combined into a single unified vector part. Combining the vectors ensures that the relative spatial relationship between the segmented image geometry and the frame-engagement features is preserved during CNC routing. This unified vector part enables simultaneous fabrication of image features and frame-engagement features, reduces cumulative alignment error, and improves repeatability across multiple production runs.

At step (118), the digital vector file generated at step (116) is exported in a machine-readable fabrication format suitable for execution by a computer numerical control (CNC) routing system or other automated subtractive fabrication equipment. The exported file may comprise vector paths, tool-path instructions, or a combination thereof, and may be provided in one or more standard formats compatible with CNC controllers. The exported data defines material-retention regions and material-removal regions corresponding to the segmented image geometry and frame-engagement features.

In one embodiment, the exported file is used to route or cut negative spaces through one or more sheets of transparent or translucent material, such as clear acrylic, cast acrylic, extruded acrylic, polycarbonate, glass, or other machinable sheet materials. The acrylic sheets may have a thickness selected based on structural and aesthetic considerations, for example in the range of approximately ⅛ inch to 1 inch, more specifically ¼ inch to ¾ inch, and in certain embodiments approximately ⅜ inch or ½ inch.

Routing may be performed using a rotary cutting tool, such as an end mill or spiral bit. In exemplary embodiments, a cutting bit having a nominal diameter of approximately ⅛ inch is used. In other embodiments, cutting bits having diameters in the range of approximately 1/16 inch to ¼ inch may be employed, with bit selection determined by minimum feature size, bar spacing, material thickness, and desired edge quality. Smaller bit diameters enable finer detail at the expense of longer machining time, while larger bit diameters improve throughput and rigidity for larger features.

During routing, the CNC system executes the toolpath instructions to physically remove material from the acrylic sheet, thereby forming negative spaces having geometries defined by the vector layout. Routing parameters such as spindle speed, feed rate, depth of cut, and step-down may be selected based on material properties and tool diameter. In some embodiments, the routing operation is performed in multiple passes to reduce tool load and improve edge finish.

In certain embodiments, two substantially identical acrylic sheets are routed using the same vector file to form corresponding front and rear layers of the sculpture. The identical routing ensures alignment of negative spaces and segmented bars when the layers are assembled. In other embodiments, a single acrylic sheet is routed to form a monolithic sculpture, or different vector files may be used to create layered or offset effects between multiple sheets.

In some embodiments, the CNC routing operation is performed under closed-loop control, wherein feedback from the machine tool, such as tool position, spindle load, or completion status, is monitored to ensure dimensional accuracy and repeatability. The exported vector file thus serves as a direct control input to the fabrication equipment, governing physical material-removal operations rather than merely representing a visual design.

At step (120), the source material is adhered to one or more acrylic substrates to form a composite layered structure that cooperates with the previously formed negative spaces to reconstruct the intended image. In one embodiment, the source material comprises pre-cut photographic film strips, such as 35 mm film or 16 mm film, selected and indexed to correspond to discrete portions of the overall image segmentation defined by the vector layout. In other embodiments, other film formats, transparencies, printed media, or image-bearing substrates may be used, provided they are compatible with the acrylic substrate and adhesion process.

The film strips are positioned on a front surface of a first acrylic sheet such that each strip aligns with corresponding bar regions and negative spaces formed during CNC routing. Alignment may be performed manually using visual guides or automatically using registration features, datum edges, or alignment marks incorporated into the routed acrylic geometry. The source material is then adhered to the acrylic sheet using a transparent, pH-neutral, archival-quality adhesive, such as a pressure-sensitive double-sided tape or adhesive film. In exemplary embodiments, the adhesive exhibits long-term chemical stability, low outgassing, and optical clarity to avoid discoloration or distortion of the source material over time.

In some embodiments, the adhesive layer has a thickness in the range of approximately 0.05 mm to 0.5 mm, more preferably 0.1 mm to 0.3 mm, to provide sufficient bonding strength while minimizing optical separation between the source material and the acrylic surface. Excess source material extending beyond the intended bar regions may be trimmed using the routed acrylic edges as a guide, ensuring clean boundaries that align with the segmentation geometry.

Following adhesion of the source material to the first acrylic sheet, a second acrylic sheet may be aligned over the adhered source material to form a sandwiched assembly. The second acrylic sheet may be substantially identical in size and geometry to the first sheet and may include matching negative spaces to preserve visual alignment. In this configuration, the source material is captured between the two acrylic sheets while the front surface of the source material remains exposed to ambient air, either through the negative spaces or through an intentional gap, to reduce moisture accumulation, chemical interaction, and long-term degradation commonly associated with full encapsulation.

In other embodiments, the source material may be adhered to a single acrylic layer without a second sheet, resulting in a monolithic structure. In further embodiments, the source material may be partially encapsulated using selective protective coatings, such as UV-resistant sprays, anti-static coatings, or archival varnishes, applied to exposed regions to improve durability while preserving airflow. In still further embodiments, spacers or micro-standoffs may be used between acrylic layers to maintain a controlled air gap around the source material.

At step (122), frame assembly and drilling occur. This step comprises mechanically integrating the fabricated acrylic assembly with a structural frame system that provides retention, alignment, load distribution, and protection during handling and display. In one embodiment, the acrylic assembly is positioned within a custom multi-part frame, such as a two-part powder-coated aluminum frame comprising an inner frame portion and an outer frame portion. In other embodiments, the frame may be formed from wood, steel, stainless steel, composite materials, engineered polymers, or combinations thereof, selected based on desired structural rigidity, weight, corrosion resistance, and aesthetic requirements.

The acrylic assembly is placed within the inner frame portion and temporarily clamped or fixtured to maintain positional alignment during drilling operations. Clamping may be performed using mechanical clamps, compression fixtures, or temporary fasteners to prevent movement of the acrylic layers relative to the frame. In some embodiments, protective spacers or gaskets may be positioned between the acrylic and frame surfaces to prevent scratching or stress concentration.

Holes are then drilled through the frame at predetermined locations selected to evenly distribute mechanical loads and maintain dimensional stability of the assembly. In exemplary embodiments, holes are drilled at four equidistant positions along the top edge and four equidistant positions along the bottom edge, although other quantities and spacing patterns may be used depending on frame size and material. In some embodiments, the hole spacing is selected within a range of approximately 2 inches to 8 inches between adjacent holes, more preferably 3 inches to 6 inches, to balance retention strength with ease of assembly.

Following drilling, the frame may be partially or fully disassembled to prepare for fastener installation. The inner frame portion is then tapped to create threaded apertures configured to receive mechanical fasteners. In exemplary embodiments, the tapped apertures are sized to receive stainless steel bolts, such as M4, M5, M6, or equivalent imperial fasteners, although other fastener sizes and materials may be used. The selection of stainless steel fasteners provides corrosion resistance and long-term structural stability.

Corresponding clearance holes are drilled in the outer frame portion. The clearance holes have diameters larger than the fastener shank to allow free passage of the fasteners without thread engagement. In some embodiments, the clearance hole diameter exceeds the fastener diameter by approximately 0.25 mm to 1.5 mm, accommodating manufacturing tolerances and thermal expansion differences between frame components.

The frame is then reassembled, with the acrylic assembly captured between the inner and outer frame portions. Fasteners are inserted through the clearance holes in the outer frame and threaded into the tapped apertures of the inner frame, thereby clamping the acrylic assembly securely in place. The applied clamping force is distributed across the frame geometry to avoid localized stress concentrations that could cause cracking or deformation of the acrylic.

In some embodiments, additional functional features may be incorporated during frame assembly, including vibration-damping elements, insulating spacers, or compliant gaskets to accommodate thermal expansion and reduce mechanical stress. The frame geometry may further conceal the top and bottom edges of the acrylic assembly, masking minor fabrication tolerances and providing a clean visual boundary.

Accordingly, the frame assembly and drilling step constitutes a mechanically significant integration stage that transforms the fabricated acrylic components into a finished, structurally stable article suitable for transport, installation, and long-term display. The disclosed drilling patterns, fastener configurations, and assembly procedures provide functional advantages in load distribution, alignment accuracy, and durability, rather than representing arbitrary or aesthetic design choices.

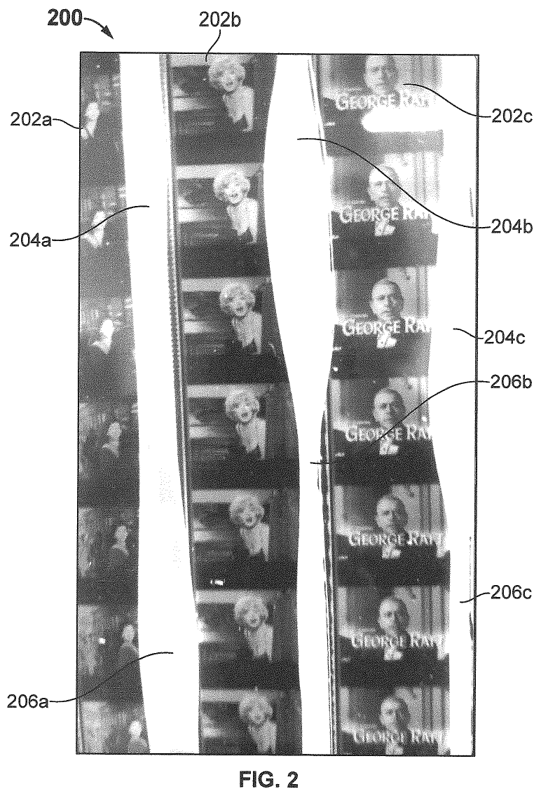

Referring now to FIG. 2, components of an acrylic sculpture formed using relatively small source material in accordance with the method of FIG. 1 are shown generally at (200). In this embodiment, a plurality of thumbnail-sized source images (202a-202c) are used as the source material. Each thumbnail image may correspond to an individual frame of photographic film, a reduced-resolution digital image, or another small-format image segment derived from a larger collection of related images.

The thumbnail images (202a-202c) are arranged in a plurality of elongated, vertically oriented strings or columns, each string comprising one or more thumbnail images positioned in a stacked configuration. In some embodiments, a given string may include repeated instances of the same thumbnail image, while in other embodiments a string may include a sequence of different thumbnail images. The selection and ordering of thumbnail images within each string may be performed manually or automatically based on image content, tonal distribution, or other selection criteria.

The vertically oriented strings of thumbnail images are separated by negative spaces (204a-204c) and (206a-206c) formed as a result of the CNC routing process described above. These negative spaces extend through the thickness of the acrylic substrate and define regions of material removal that alternate with regions retaining the source material. The widths and spacing of the negative spaces are controlled by the vector layout and fabrication parameters, and are selected to cooperate optically with the retained thumbnail images.

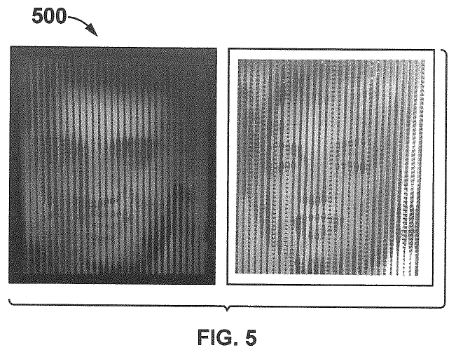

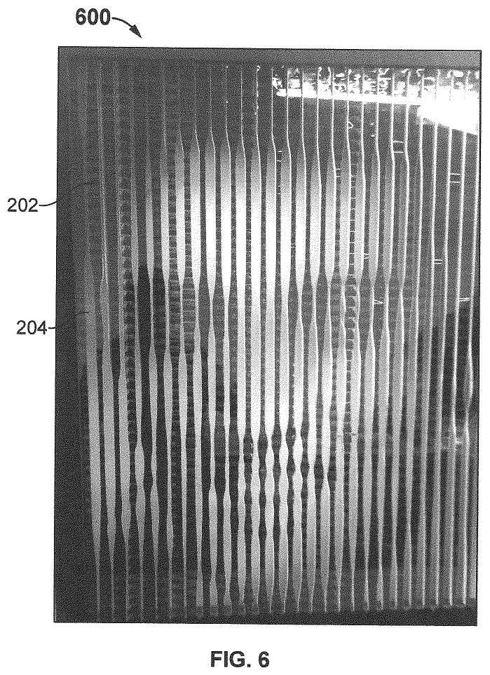

Collectively, the alternating arrangement of thumbnail-image strings and negative spaces forms a segmented composite structure in which the individual thumbnail images function as discrete visual elements that contribute local texture and detail, while the negative spaces function as contrast-enhancing regions that visually separate adjacent strings. When viewed from an appropriate distance or viewing angle, the thumbnail images and negative spaces optically integrate to reconstruct a larger, coherent image corresponding to the overall subject matter illustrated in FIGS. 5 and 6.

The negative spaces (204) and (206) are functionally significant, as they increase luminance contrast between adjacent image-bearing regions and introduce depth cues by allowing background light and color to interact with the sculpture. This interaction enhances edge definition, tonal separation, and three-dimensional perception of the reconstructed image. The depth of the negative spaces, combined with the thickness of the acrylic substrate, further contributes to shadowing effects that vary with ambient lighting conditions, thereby reinforcing the sculptural quality of the work.

Accordingly, the embodiment of FIG. 2 demonstrates how relatively small-format source material can be systematically arranged and physically segmented to produce a large-scale, three-dimensional acrylic sculpture with enhanced visual depth and perceptual coherence. The cooperation between thumbnail image strings and CNC-formed negative spaces enables reconstruction of complex imagery from discrete components, illustrating the scalability and flexibility of the disclosed methods.

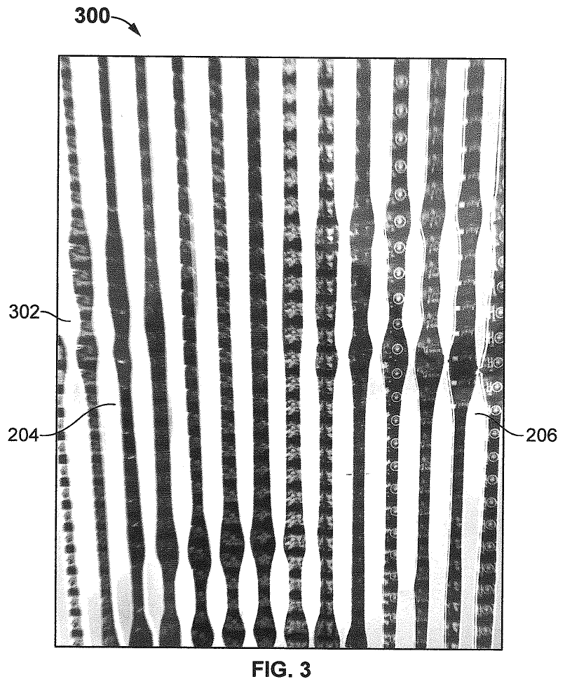

FIG. 3 illustrates a more distant view of the sculpture components at reference numeral (300), showing the cooperative interaction between retained source material and CNC-formed negative spaces when viewed at an increased viewing distance. In this configuration, alternating regions of source material and negative space are arranged in a slatted configuration, wherein each slat comprises a longitudinal region of retained acrylic carrying the source material and is separated from adjacent slats by negative spaces extending through the thickness of the acrylic substrate.

As shown, slat (302) is positioned adjacent negative spaces (204) and (206). Each slat functions as a structural and optical carrier for a portion of the source material, while the negative spaces function as optical separators that define boundaries between adjacent slats. The spacing, width, and depth of the negative spaces are selected in accordance with the vector layout and fabrication parameters described above, and are configured to cooperate with the slats to produce a coherent visual image when viewed at a macroscopic distance.

When the sculpture is installed, a background surface located behind the acrylic assembly, such as a wall, panel, or mounting surface, becomes visible through the negative spaces. In one embodiment, a light-colored or white background surface is used to maximize luminance contrast between the retained source material and the negative spaces. The visibility of the background through the negative spaces increases edge definition and enhances perceptual separation between adjacent slats, thereby contributing to the reconstructed image.

In other embodiments, the background surface may comprise non-white colors, gradients, textures, patterns, or materials, such as painted walls, textured panels, metallic surfaces, or fabric backings. Variation in background color or texture alters the contrast relationship between the negative spaces and the slats, enabling controlled modification of the visual appearance of the sculpture without altering the fabricated acrylic components. In some embodiments, the background may be intentionally selected to complement or accentuate specific tonal regions of the reconstructed image.

The slatted configuration illustrated in FIG. 3 further produces a three-dimensional visual effect by introducing depth cues resulting from the physical separation between the slats and the background surface. Light passing through the negative spaces creates shadows and highlights that vary with ambient lighting conditions and viewing angle. These dynamic lighting interactions enhance the sculptural quality of the work and reinforce perception of depth and dimensionality beyond the planar image content.

Accordingly, FIG. 3 demonstrates how the alternating arrangement of slats and negative spaces functions not only as a structural segmentation of the source material, but also as a perceptual reconstruction mechanism that leverages background interaction, contrast modulation, and depth cues to produce a large-scale three-dimensional image from segmented acrylic components. This configuration illustrates the functional relationship between fabrication geometry, installation environment, and visual outcome.

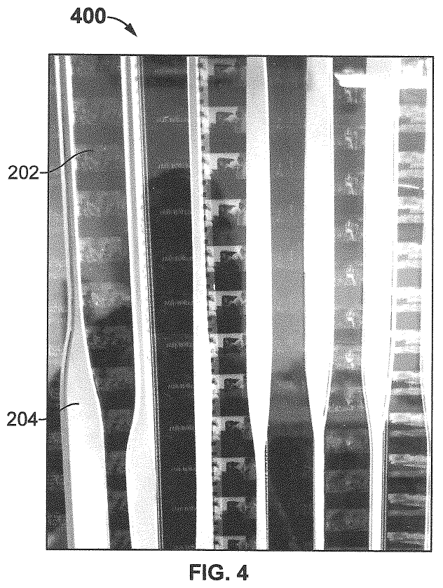

FIG. 4 shows a close-up view of the sculpture at reference numeral (400), illustrating the detailed interaction between the source material (202), the slats (302), and the negative spaces (204) and (206) at a localized scale. This view highlights how the precise placement, width, depth, and edge geometry of the negative spaces, formed by CNC routing of the acrylic substrate, cooperate with the retained slats carrying the source material to produce localized contrast and depth effects that contribute to the overall perceptual reconstruction of the larger image.

At this close range, each slat (302) is shown as a discrete structural element comprising retained acrylic material supporting a portion of the source material (202). The adjacent negative spaces (204) and (206) extend through the thickness of the acrylic substrate and define sharply bounded regions of material removal. The routed edges of the negative spaces may be substantially vertical, chamfered, radiused, or otherwise shaped based on tool geometry and routing parameters, and these edge characteristics influence how light interacts with the slat boundaries.

The geometry of the negative spaces is functionally significant. The width and spacing of the negative spaces control the degree of optical separation between adjacent slats, while the depth of the negative spaces, corresponding to the acrylic thickness, introduces shadowing effects that vary with ambient lighting and viewing angle. These shadow gradients enhance local contrast at slat boundaries and assist the human visual system in distinguishing adjacent image segments, even when the underlying source material exhibits subtle tonal variation.

As shown in FIG. 4, the interaction between the source material (202) and the negative spaces (204), (206) produces edge-enhancement effects at a micro scale, wherein transitions between image-bearing regions and background-visible regions become visually emphasized. When viewed from an appropriate distance, these localized contrast enhancements aggregate across the slatted structure to form a coherent macroscopic image. At closer viewing distances, the individual slats and negative spaces remain visually discernible, reinforcing the sculptural and layered nature of the work.

The close-up view further illustrates how the accuracy of CNC routing, including toolpath fidelity, edge smoothness, and dimensional consistency, directly impacts the perceptual quality of the sculpture. Irregularities in negative-space geometry could introduce unintended visual artifacts, whereas the precisely routed acrylic lines shown in FIG. 4 produce consistent, repeatable optical behavior across the sculpture.

Accordingly, FIG. 4 demonstrates that the disclosed fabrication process yields micro-scale geometric features that are deliberately engineered to influence macro-scale visual perception. The cooperation between source material, slats, and negative spaces at this level exemplifies how the disclosed methods translate digital segmentation data into physical structures that collectively reconstruct a larger image with depth, contrast, and three-dimensional presence.

FIG. 5 illustrates exemplary complete three-dimensional acrylic sculptures at reference numeral (500) formed from thumbnail-scale source material using the methods described herein. In one illustrative embodiment, the sculpture depicts a reconstructed portrait of Elvis Presley at reference numeral (502), and in another illustrative embodiment, the sculpture depicts a reconstructed portrait of Marilyn Monroe at reference numeral (504). These embodiments are provided solely as recognizable reference examples to demonstrate the technical capability of the disclosed methods to reconstruct complex, high-fidelity imagery from segmented and physically separated source material.

As shown in FIG. 5, each completed sculpture comprises a plurality of vertically oriented slats carrying thumbnail images, separated by CNC-formed negative spaces, and integrated into a unified three-dimensional structure. Although the source material consists of relatively small individual images, the disclosed segmentation, vectorization, and fabrication processes cause the retained image regions and negative spaces to optically integrate when viewed at a macroscopic distance. This integration results in perceptual reconstruction of facial features, contours, and tonal gradients associated with the depicted subject matter.

The sculptures illustrated at (502) and (504) further demonstrate that the disclosed methods are capable of reconstructing highly recognizable human facial imagery, which places significant demands on spatial accuracy, contrast control, and perceptual coherence. Facial imagery is particularly sensitive to distortions or misalignment; accordingly, successful reconstruction of such imagery evidences the precision of the raster-to-vector conversion, bar-spacing selection, negative-space geometry, and CNC routing accuracy described above.

Importantly, the embodiments of FIG. 5 are not limited to portraits or celebrity imagery. The illustrated sculptures demonstrate that the disclosed techniques are capable of reconstructing a wide range of subject matter, including landscapes, abstract designs, architectural forms, logos, text, or other complex visual compositions, using thumbnail or small-format source material. The ability to scale from small individual image units to a large, coherent three-dimensional sculpture illustrates the scalability and flexibility of the disclosed image-to-fabrication pipeline.

Additionally, FIG. 5 illustrates the three-dimensional nature of the completed sculptures. The physical depth introduced by the acrylic thickness, combined with the negative spaces and interaction with ambient lighting, produces shadowing and depth cues that vary with viewing angle and illumination. These effects enhance the sculptural quality of the work beyond a flat image reproduction and contribute to the perception of dimensionality and presence.

FIG. 6 shows another embodiment at reference numeral (600) in which the individual thumbnail images forming the source material are shown in greater detail. This view illustrates how each thumbnail image functions as a discrete image-bearing element retained on a corresponding slat and separated from adjacent thumbnails by CNC-formed negative spaces. The increased level of detail visible in FIG. 6 highlights the preservation of fine image features, such as grain, texture, and tonal variation, achieved through the disclosed image-processing, vectorization, and fabrication steps.

In some embodiments, an archival adhesive layer or protective tape is applied over at least a portion of the source material after adhesion to the acrylic substrate. The archival adhesive or tape may be transparent, pH-neutral, and chemically stable, and may be selected to minimize outgassing, yellowing, or embrittlement over time. In exemplary embodiments, the protective tape has a thickness in the range of approximately 0.025 mm to 0.25 mm, more preferably 0.05 mm to 0.15 mm, providing mechanical protection against abrasion and handling while maintaining optical clarity.

In further embodiments, a UV-protective spray or coating is applied to exposed surfaces of the source material and/or the acrylic substrate to reduce degradation caused by ultraviolet and visible light exposure. The UV-protective coating may comprise a clear varnish, lacquer, polymeric coating, or other UV-absorbing or UV-blocking formulation. In exemplary embodiments, the coating is selected to block at least approximately 90% to 99% of UV radiation below a predetermined wavelength threshold, while remaining substantially transparent in the visible spectrum.

Application of archival adhesives, protective tapes, and UV-protective coatings is functionally significant, as the thumbnail images are often derived from photographic film or other media that are susceptible to fading, discoloration, or chemical degradation when exposed to light, oxygen, or environmental contaminants. By selectively protecting the source material while preserving airflow through negative spaces, the disclosed embodiments balance long-term preservation with the optical requirements of the segmented, three-dimensional structure.

FIG. 6 further illustrates that, even with protective layers applied, the thumbnail images remain visually distinct and cooperatively reconstruct the larger image when viewed from an appropriate distance. The protective elements therefore do not obscure the segmentation geometry or interfere with the optical interaction between retained image regions, negative spaces, and background surfaces.

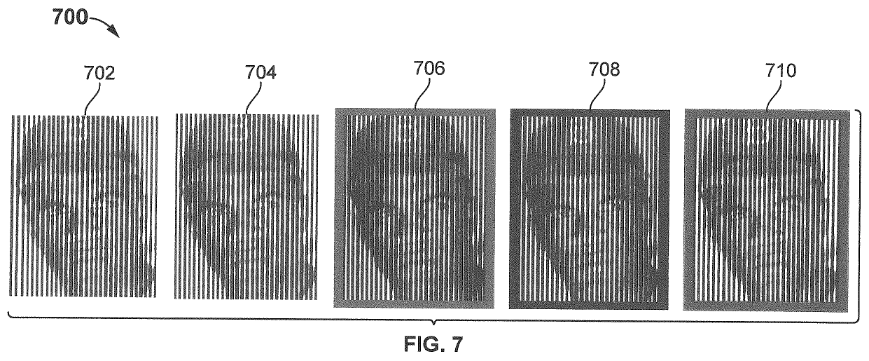

FIG. 7 illustrates an exemplary framing and integration process at reference numeral (700) for preparing the fabricated acrylic sculpture for final assembly, finishing, and display. The process shown in FIG. 7 represents a continuation of the image-to-fabrication pipeline and demonstrates how the segmented acrylic components are structurally unified and mechanically retained within a frame system.

At step (702), the image is vectorized in accordance with the raster-to-vector conversion processes described above. The resulting vector geometry defines the segmented slats, negative spaces, and boundary edges of the acrylic component. At step (704), the top and bottom edges of the vectorized image are extended by a predetermined margin to accommodate engagement with an interframe. This extension provides additional material for structural retention, tolerance compensation, and concealment by the frame, and is selected based on acrylic thickness, fabrication tolerances, and finishing requirements.

At step (706), an interframe is added to the vector geometry. The interframe functions as a structural coupling element that secures the plurality of segmented slats into a single, rigid unit while maintaining their relative spacing and alignment. The interframe may comprise one or more elongated frame members positioned along the top and bottom edges of the segmented image, and may include apertures, slots, or relief features to accommodate fasteners, clamps, or other retention mechanisms. By mechanically linking the slats, the interframe reduces relative movement between slats during handling and installation and improves overall structural stability.

At step (708), the interframe geometry and the image segmentation geometry are combined into a single unified vector part. This combined vector part is then used for milling or routing, ensuring that the interframe and image components are fabricated with precise spatial alignment in a single operation. Combining the geometries reduces cumulative alignment error, simplifies fabrication setup, and ensures that interframe features are registered accurately relative to the segmented slats.

At step (710), an outer frame, such as an aluminum frame, is provided to enclose and retain the acrylic assembly. The outer frame may comprise multiple frame members forming a perimeter enclosure and may be configured to mechanically engage the interframe and/or the extended edge regions of the acrylic component. In some embodiments, the outer frame is formed from aluminum to provide a combination of rigidity, low weight, and corrosion resistance, although other materials may be used.

The acrylic component is dimensioned to be slightly smaller than the interior opening of the outer frame, allowing clearance for material thickness variation, thermal expansion, and post-fabrication finishing operations such as sanding or polishing. In this configuration, the top and bottom edges of the acrylic component are concealed by the outer frame, masking minor fabrication tolerances and producing a clean, finished visual boundary. The frame thereby serves both a structural and functional role, securing the segmented acrylic sculpture while enhancing durability and presentation.

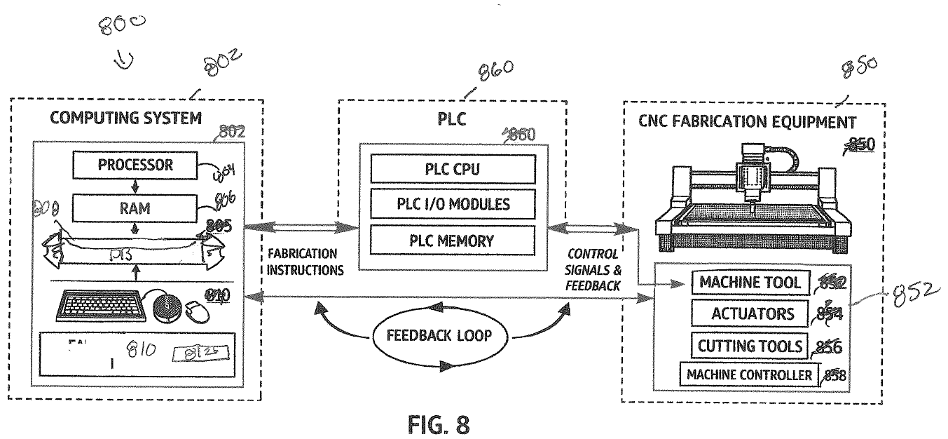

Referring now to FIG. 8, a system architecture (800) for implementing the methods described herein is shown. The system (800) comprises a computing system (802) operatively coupled to computer-controlled fabrication equipment (850). The computing system (802) is configured to execute image-processing, vector-generation, and fabrication-control operations that collectively enable the transformation of digital source media into a physical three-dimensional acrylic sculpture.

The computing system (802) includes one or more processors (804), a memory (806), and one or more storage devices (808). The processors (804) may include general-purpose processors, graphics processing units (GPUs), or a combination thereof. The memory (806) stores executable instructions which, when executed by the processors (804), cause the computing system to perform the image-processing, vectorization, and fabrication-preparation steps described with reference to FIG. 1. The storage devices (808) store source material files, intermediate raster images, vector geometry files, and fabrication-ready tool-path data.

The computing system (802) further includes an image-processing module (810), a vector-generation module (812), and a fabrication-control module (814), each of which may be implemented as software instructions stored in memory (806) and executed by processors (804). The image-processing module (810) is configured to perform resolution scaling, grayscale conversion, filtering, thresholding, and tonal adjustment operations on source material. The vector-generation module (812) is configured to convert raster image data into machine-interpretable vector geometry defining bar structures, negative spaces, and frame boundaries. The fabrication-control module (814) is configured to generate or transmit fabrication instructions derived from the vector geometry.

The system (802) is in communication with fabrication equipment (850) which comprises a computer numerical control (CNC) routing system (852) configured to receive fabrication instructions from the computing system (802). The CNC routing system (852) includes one or more actuators, cutting tools, and controllers that execute tool-path instructions to physically remove material from acrylic substrates. The CNC routing system may be directly connected to the computing system (802) or may receive instructions via a removable storage medium or network connection.

In operation, the computing system (802) executes the image-processing module (810) and vector-generation module (812) to produce fabrication-ready vector data. The fabrication-control module (814) transmits corresponding tool-path instructions to the CNC routing system (852). The CNC routing system (852) then executes the instructions to physically transform raw acrylic sheets into routed components having predetermined negative spaces, which are subsequently assembled with source material and framing components as described herein.

In some embodiments, the system architecture (800) further includes an industrial automation controller, such as a programmable logic controller (PLC) (860), operatively coupled between the computing system (802) and the fabrication equipment (850). The PLC (860) is configured to execute real-time control logic for coordinating motion control, tool actuation, safety interlocks, and sequencing of fabrication operations performed by the machine tool.

The PLC (860) is communicatively coupled to the computing system (802) via the fabrication-control interface (812) and to the machine tool (852) via one or more industrial communication buses, such as fieldbus, industrial Ethernet, or other deterministic control networks. In this configuration, the computing system (802) generates high-level fabrication instructions, vector-derived tool paths, and process parameters, which are transmitted to the PLC (860) for execution and real-time control.

The foregoing description illustrates exemplary embodiments of the present disclosure The described steps may be performed in different orders, combined, omitted, or supplemented without departing from the scope of the disclosure. Numerous modifications and other embodiments will be apparent to those skilled in the art in view of the foregoing disclosure. The disclosure is therefore not limited to the specific embodiments described, but rather is defined by the claims and their equivalents.

I claim:

1. A method for fabricating a three-dimensional craft product, comprising:
processing, by a computing system, a source image to generate a manufacturing-ready digital representation, the processing including conditioning the source image to enhance contrast and feature stability for physical fabrication;
generating, from the processed source image, vector geometry defining a plurality of material-retention regions and material-removal regions corresponding to image-derived segmentation geometry;
converting the vector geometry into machine-readable fabrication data configured to control automated material-removal equipment;
executing, using computer-controlled fabrication equipment, a material-removal operation on at least one transparent or translucent substrate in accordance with the fabrication data to form a plurality of negative spaces extending through the substrate and a plurality of retained structural members arranged in a predetermined spatial relationship;
aligning physical source media with the retained structural members such that portions of the source media are exposed through the negative spaces formed in the substrate;
securing the physical source media to the substrate to form a composite structure in which the retained structural members, negative spaces, and source media cooperatively interact with ambient light to produce a composite visual image having depth-dependent visual characteristics; and
assembling the composite structure into a framed article of manufacture configured to maintain a spaced relationship between the composite structure and a background surface to enhance optical contrast and depth perception.

2. The method of claim 1, wherein processing the source image comprises scaling the source image to a resolution selected based on at least one of a desired physical size of the craft product, a minimum feature size achievable by the computer-controlled fabrication equipment, and a cutting tool diameter.

3. The method of claim 1, wherein conditioning the source image comprises converting the source image to grayscale or selectively desaturating one or more color channels to enhance tonal separation prior to vector geometry generation.

4. The method of claim 1, wherein generating the vector geometry comprises segmenting the processed source image into a plurality of elongated structural regions separated by image-derived negative-space regions, the segmentation being defined such that retained material regions correspond to image information and removed material regions correspond to background or contrast-enhancing regions.

5. The method of claim 4, wherein the elongated structural regions comprise a plurality of parallel or substantially parallel slats having widths and spacings selected as a function of at least one of pixel density of the source image, minimum manufacturable feature size, and a cutting diameter of the computer-controlled fabrication equipment.

6. The method of claim 5, wherein the negative-space regions extend fully through a thickness of the substrate and are dimensioned to permit background visibility and ambient light transmission between adjacent slats, thereby optically contributing to reconstruction of the source image at a macroscopic viewing distance.

7. The method of claim 1, wherein executing the material-removal operation comprises routing substantially identical negative-space geometries through two transparent substrates configured to be aligned as front and rear layers of the composite structure.

8. The method of claim 1, wherein securing the physical source media comprises adhering image-bearing film strips, image segments, or transparencies to the substrate using a transparent archival adhesive while maintaining at least partial exposure of the source media to ambient air.

9. The method of claim 1, wherein assembling the composite structure into the framed article comprises positioning the composite structure within a rigid frame that conceals edge regions of the substrate while maintaining an air gap between the composite structure and the background surface.

10. The method of claim 1, further comprising applying at least one protective treatment to the physical source media, the protective treatment comprising at least one of a UV-protective coating, an anti-static coating, or a transparent protective film configured to preserve optical performance over time.

11. A three-dimensional craft product, comprising:
at least one transparent or translucent substrate having a plurality of negative spaces extending through a thickness of the substrate, the negative spaces being formed by computer-controlled material removal based on image-derived segmentation geometry;
a plurality of retained structural members defined between the negative spaces, the retained structural members being arranged in a predetermined spatial relationship corresponding to a processed source image;
physical source media secured to the substrate and aligned with the retained structural members such that portions of the source media are exposed through the negative spaces;
wherein the retained structural members and the negative spaces cooperatively interact with ambient light and a background surface to optically reconstruct a composite visual image when viewed from a macroscopic viewing distance; and
a frame configured to support the substrate in a spaced relationship relative to the background surface to permit light transmission through the negative spaces and enhance visual depth and contrast.

12. The craft product of claim 11, wherein the retained structural members comprise a plurality of elongated slats separated by the negative spaces, the slats being arranged in a parallel or substantially parallel configuration.

13. The craft product of claim 12, wherein the slats have widths and spacings selected as a function of at least one of pixel resolution of the processed source image, a minimum manufacturable feature size, and a cutting tool diameter used during the computer-controlled material removal.

14. The craft product of claim 11, wherein the negative spaces extend completely through the substrate to permit background visibility and ambient light transmission between adjacent retained structural members.

15. The craft product of claim 11, comprising at least two transparent substrates aligned in a layered configuration, with the physical source media positioned between the substrates without full encapsulation to permit airflow around the source media.

16. The craft product of claim 15, wherein the substrates are substantially identical in geometry and include matching negative-space patterns to preserve optical alignment between layers.

17. The craft product of claim 11, wherein the physical source media comprises photographic film strips, transparencies, or image-bearing segments derived from analog or digital source material.

18. The craft product of claim 11, wherein the physical source media is secured using a transparent archival adhesive selected to minimize chemical degradation and optical distortion over time.

19. The craft product of claim 11, further comprising at least one protective treatment applied to the physical source media, the protective treatment comprising a UV-protective coating, a transparent protective film, or an anti-static layer.

20. The craft product of claim 11, wherein the frame is configured to conceal edge regions of the substrate while maintaining a controlled air gap between the substrate and the background surface to enhance visual depth and contrast.
